(19) United States
(12) Patent Application Publication
(10) Pub. No.: US 2025/0190623 A1
(43) Pub. Date: Jun. 12, 2025

(54) AUTOMATED CHATBOTS THAT DETECT PRIVACY DATA SHARING AND LEAKAGE BY OTHER AUTOMATED CHATBOT SYSTEMS

(71) Applicant: PAYPAL, INC., San Jose, CA (US)

(72) Inventor: Ramalingam Sreenidurai, Pollachi (IN)

(21) Appl. No.: 18/537,705

(22) Filed: Dec. 12, 2023

(51) Int. Cl. G06F 21/62; H04L 9/40; H04L 51/02

(52) U.S. Cl. CPC G06F 21/6263; H04L 63/04; H04L 51/02

(57) ABSTRACT

There are provided systems and methods for automated chatbots that detect privacy data sharing and leakage by other automated chatbot systems. A service provider and other chatbot services, including an electronic transaction processor, may provide self-service channels for assistance through chatbot and other automated computing processes. However, these chatbots may be regulated by compliance with privacy protection requirements, and therefore use of the chatbots and/or user data when responding to users via chatbots in chat sessions may be noncompliant and/or attacked by malicious users to compromise privacy protected data. In order to facilitate detection of leaks and shares by chatbots, an AI for a privacy protection chatbot may be trained on regulations for chatbot use and/or data security and privacy protection. The chatbot may then interact with other chatbots and question the other chatbots using the trained AI model to detect whether privacy protected data is exposed.

### TECHNICAL FIELD

The present application generally relates to automated data privacy protection and more particularly to building and utilizing automated chatbots to interact with other chatbot systems to identify sharing, leakage, or other exposure of privacy protected data.

### BACKGROUND

Service providers may have large computing systems and services that provide automated interfaces and interactions with different end users, such as customers, clients, internal users and teams, and the like. Users may interact with chatbots, automated assistance channels, interactive voice response (IVR) systems, and the like, which may also be accessed through text messaging, emails, push notifications, instant messaging, and other electronic communication channels. As hackers and other malicious users or entities become more sophisticated, they may perform different computing attacks and other malicious conduct against the service provider to compromise systems and/or commit fraud. For example, fraudsters may attempt to compromise sensitive data to access and/or utilize such data for fraudulent purposes, such as to perform fraudulent electronic transaction processing or account takeover. This may include interacting with the chatbots to illicitly or fraudulently obtain and/or access privacy protected data, including personally identifiable data (PII), know your customer (KYC) data, financial data, and the like that may be privacy protected.

Fraudsters may identify certain questions, queries, and/or conversational flows that lead to privacy protected data being accidentally leaked, shared, or otherwise exposed by an automated chatbot responding to a user. Many service providers attempt to provide strong privacy protection, and may be required to comply with laws, regulations, and company rules or objectives governing privacy protection. However, as computing attacks become more sophisticated, and chatbot systems change and evolve over time, fraudsters and malicious actors may find different ways to compromise data from such chatbots. Thus, it is desirable for service providers to implement an automated and intelligent system to detect unwanted exposure of privacy protected data by chatbot systems.

### BRIEF DESCRIPTION OF THE DRAWINGS

FIGS. 1A and 1B are block diagrams of networked systems suitable for implementing the processes described herein, according to an embodiment;

FIGS. 2A-2C are exemplary systems architectures including a privacy protection chatbot interacting with other chatbot systems to identify and protect from exposures of privacy protected data by the other chatbot systems, according to an embodiment;

FIGS. 3A-3C are exemplary user interfaces of chat sessions between a privacy protection chatbot and a chatbot system to detect whether privacy data is exposed during chat sessions and other communications, according to an embodiment;

FIG. 4A is an exemplary diagram of interactions between a service provider server that provides a privacy protection chatbot and another chatbot server that provides a chatbot that is monitored to detect whether privacy data is exposed during use, according to an embodiment;

FIG. 4B is a flowchart for automated chatbots that detect privacy data sharing and leakage by other automated chatbot systems, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for automated chatbots that detect privacy data sharing and leakage by other automated chatbot systems. Systems suitable for practicing methods of the present disclosure are also provided.

In large computing systems of service providers, automated help or assistance may be provided through chatbots in an email channel, a digital alert channel, a text message channel, a push notification channel, an instant message channel, or the like. These chatbots and other automated computing processes may allow end users of a service provider to engage in self-service assistance options associated with one or more services of the service provider. For example, an online transaction processor may provide automated assistance options for account setup, authentication, account usage (e.g., during electronic transaction processing), mobile device or application usage, payment information and/or service, and the like. These automations for self-service options provide conversational flows that provide assistance via chat sessions and automated chat dialogs and other communication through different electronic communication channels. A conversational artificial intelligence (AI) platform or system may be used to converse with users, which may include machine learning (ML) models, neural networks (NNs), and other AI systems for conversing with users.

Conversations between chatbots and users during chat sessions may include users submitting questions or requests, such as by querying or commanding the chatbots, and receiving corresponding answers or responses. For example, users may issue requests or commands that chatbots may respond to with privacy protected data, such as PII, financial data, or other data that may be protected by laws, regulations, rules, and/or company procedures, guidelines, and goals. This may be unintentional and may result from an unknown exploit, overlooked security breach, or the like. However, valid requests for privacy protected data may be required in some cases to provide assistance and/or computing services to users, though these requests may normally require proper authentication and validation of users prior to the chatbot responding with privacy protected data. Malicious and bad actors may attempt to bypass or avoid these safeguards through certain questions, flows, or other exploits and/or computing attacks.

As such, malicious actors and other users may attempt to breach various computing systems and restricted data by circumventing security layers and required authorizations for permissions to access data, content, and/or computing resources (e.g., applications, databases, data, operations, networks, etc.) when interacting with chatbots. These parties attempt to find vulnerabilities or weaknesses in particular chatbot conversational flows, response parameters, and the like to data when not authorized. To prevent these types of abuses, a service provider, in some embodiments, may implement a privacy protection chatbot that may identify exposures of privacy protected data. This privacy protected data may correspond to data that is required to be protected by law or regulation for a particular location, region, country, or the like, and/or may be required by the specific guidelines and goals of a company, as well as data, such as PII, an end user may not want known by unauthorized entities or individuals. As such, enforcement of protections for and preventions of exposures of privacy protected data may be required to be regulatory compliant and/or comply with company policy, goals, mission statements, and the like.

The privacy protection chatbot may be implemented as an automated service that may interact with, question, and/or command other various chatbot systems to determine if responses by those systems share, leak, or otherwise expose such privacy protected and/or sensitive data. The privacy protection chatbot may be trained using applicable laws, regulations, and/or rules, as well as generic and/or customer-specific interactions, to formulate and determine questions, commands, queries, and the like that can be exchanged with the other chatbots during a conversation, dialog, or other communication session. Based on the responses, the privacy protection chatbot may determine if privacy protected data is exposed or made accessible by the chatbots (e.g., leaked, shared, or otherwise revealed). If so, the privacy protection chatbot may implement security measures to alert system administrators and/or entities controlling the chatbots, shut the chatbots off, prevent the chatbots from responding to the same or similar questions, and/or prevent access to the data being exposed by those chatbots.

In this regard, a service provider, which may provide services to users including electronic transaction processing such as online transaction processors (e.g., PayPal®), may allow merchants, users, and other entities to process transactions, provide payments, provide content, and/or transfer funds between these users. The user may also interact with the service provider to establish an account and provide other information for the user. Other service providers may also or instead provide computing services, including social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like.

The user may also be required to provide financial information, including payment card (e.g., credit/debit card) information, bank account information, gift card information, benefits/incentives, and/or financial investments, which may be used to process transactions for items. The account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant.

All of these interactions may generate and/or process data, which may encounter issues or require users to request help or assistance. Further, the data accessed, stored, and/or utilized by the service provider may include privacy protected data, such as PII, financial data, health data, transaction data and/or histories, KYC data, and the like. As such, computing attacks, malicious and fraudulent behavior, and the like may compromise the security of digital accounts and corresponding privacy protected data including financial and personal data, such as by attacking chatbot systems that may be compromised to expose privacy protected data.

In order to provide more secure assistance options via chatbot usage with users, the service provider may wish to provide different automated help or assistance through different electronic communication channels. In particular, the service provider may train an ML model, NN, or the like for a chatbot that generates questions designed to elicit responses from other chatbots and systems that may include privacy protected data if a leak, vulnerability, or exploit exists. These may be direct questions for the data or may be more subtle questions used during a conversation that may require a response including privacy protected data (e.g., an address in response to a question regarding a past location of an event that occurred, a portion of a credit card number or its expiration date when asking about a potentially misbilled or fraudulent transaction, etc.). The privacy protection chatbot may be trained using training data that includes domain-specific knowledge for a domain associated with the assistance or communication service being provided by the other responding chatbot, such as information about payment services, account services, gifting services, merchant category, etc. The training data may also include past conversations and/or questions, including those that did elicit a response exposing privacy protected data, as well as data privacy requirements for laws, rules, or regulations governing the privacy protected data and/or other responding chatbot. Once trained, the ML model, NN, or the like for the privacy protection chatbot may be used to query other chatbots for privacy protected data and identify when such data is exposed.

As such, a trained AI model for the privacy protection chatbot may be instantiated and used to query other chatbots for responses that may include privacy protected data. Thereafter, the operations for automated conversations, questions, dialogs, and other chat communication sessions may use a conversational AI platform or system that allows for generation of a conversational flow. The conversational AI platform may be internal or external, such as IBM Watson™ or Google Dialog Flow™, as well as generative AI agents such as Chat Generative Pretrained Transformer (ChatGPT). The conversational AI platform may be selected based on the particular conversations and dialogs, as well as parameters of such dialogs and communication sessions (e.g., channel, location, region, language, platform and/or code, etc.), as well as other parameters of the receiving chatbot. For example, a language, communication channel, chatbot or automation specification, and the like may be used to select the conversational AI platform.

When generating questions, commands, or other statements designed to elicit a response from a chatbot, a dialog may be created, which includes the different conversational questions and comments. For example, the dialog may include “small talk” greetings, such as “Hello!”, “How are you?”, “Thank you for contacting us!”, and the like. Along with this “small talk” and response conversational items, questions, commands, and the like may be generated for the corresponding level of question designed to elicit responses that may include privacy protected data. This includes general questions or high-level questions that do not include or are independent of any customer-specific information, such as a name, account, email address, financial data, or the like. More specific and granular questions may include such customer-specific data and may be designed on a more specific or detailed level that attempts to determine if a chatbot may respond with privacy protected data.

The privacy protection chatbot may then connect with another chatbot of a service provider or other online platform and/or entity. The other chatbot may be used by the service provider or other online platform/entity to provide communication services to users, such as to provide assistance to users, facilitate usage of a service and/or computing system, and the like. The privacy protection chatbot may then generate, access, and/or determine one or more questions, commands, or other statements to the other chatbot and system that attempts to elicit responses with privacy protected data, thereby determining if there are leakages, sharing, or other exposure of such data. The questions may include more general high-level questions, as well as the customer-specific more granular-level questions. The questions may be previously generated and/or generated in real-time during the dialog and session including based on responses by the other chatbot.

A chat session and/or chat dialog may be initiated and started, and the privacy protection chatbot may then issue and/or transmit the question(s) to the other chatbot. Responses may then be received, which may be parsed using the ML model to identify whether any privacy protected data is found in the responses. The privacy protection chatbot may continue until all questions are queried and/or a chat session ends and may perform this activity at determined intervals or on request. If privacy protected data is detected as being provided by the other chatbot during the chat session, the privacy protection chatbot may then alert an administrator of the other chatbot. However, when residing in the same system or network, or where the privacy protection chatbot has permissions and/or authorizations, the privacy protection chatbot may issue commands to stop the other chatbot from responding to all or certain questions, prevent access to the exposed data, or the like.

Therefore, the service provider's system may provide an automated chatbot system designed to identify and protect from exposure of privacy protected data by chatbots due to leaks or shares caused by computing attacks, exploits, or the like. This allows for faster and automated detection of exposed data to prevent or reduce fraud and harm caused by such exposures. By reducing the manual effort and providing an automated systems, computing resources required for identification of data exposure may be reduced and exploits or vulnerabilities in computing systems may be identified and fixed more quickly and efficiently. As such, the privacy protection chatbot may provide a valuable tool to improve computing security systems for data privacy protections.

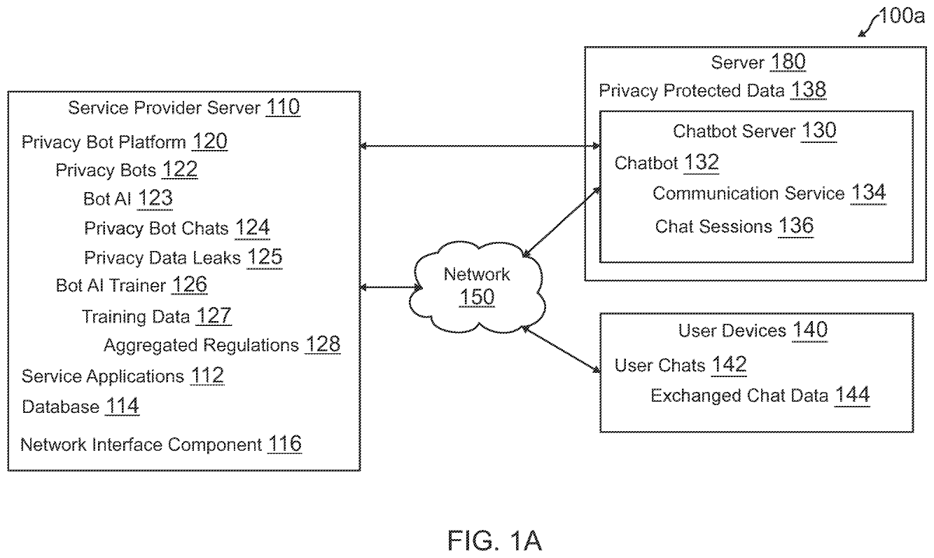

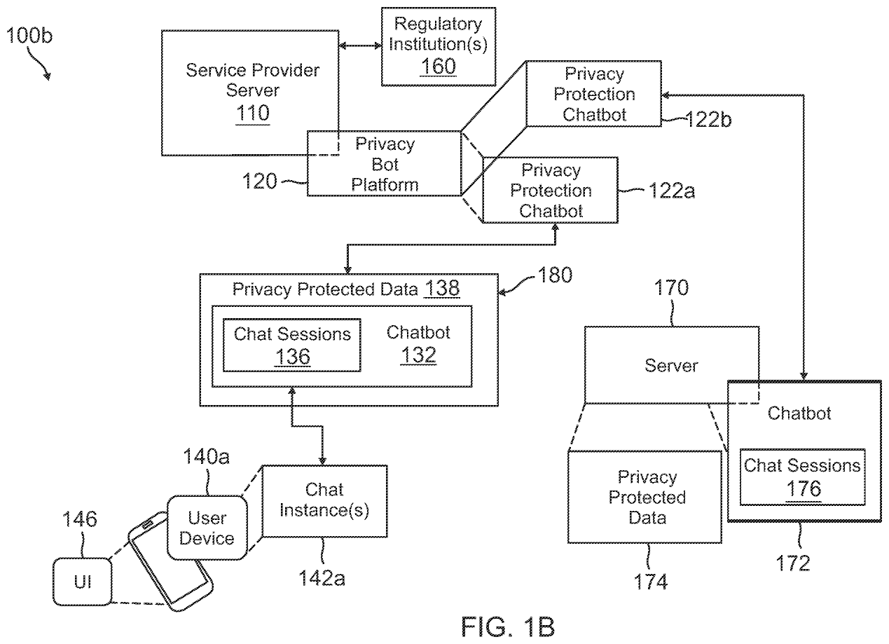

FIGS. 1A and 1B are block diagrams of networked systems suitable for implementing the processes described herein, according to an embodiment. FIG. 1A includes a block diagram of an exemplary system where a privacy protection chatbot interacts with a chatbot service that may communicate with users for automated chat services. As shown in FIG. 1A, a system 100a may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIGS. 1A and 1B may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100a includes a service provider server 110, a server 180 including a chatbot server 130, and user devices 140 in communication over a network 150. User devices 140 may be utilized by a user, customer, or the like to access a computing service or resource provided by service provider server 110 and/or chatbot server 130, where chatbot server 130 may provide a chatbot 132 to provide automated communications through chat sessions with user devices 140. Service provider server 110 may provide various data, operations, and other functions to via network 150. Chatbot server 130 may correspond to a server or other component of server 180, which includes privacy protected data 138 that may be accessed and utilized by chatbot 132. In this regard, service provider server 110 may provide a privacy bot platform 120 utilizing privacy bots 122 to detect whether chatbot 132 for chatbot server 130 exposes any of privacy protected data 138 during chat sessions and other communications.

Service provider server 110, chatbot server 130, user devices 140, and server 180 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100a, and/or accessible over network 150.

Service provider server 110 may be maintained, for example, by an online service provider, which may provide automated operations for conversational chat sessions by privacy protection chatbots with other chatbots to detect exposure of privacy protected data from leaks and/or shares during the chat sessions in electronic communication channels. In this regard, service provider server 110 includes one or more processing applications which may be configured to interact with chatbot server 130 and/or other internal and/or external chatbots and corresponding services to automate detection of privacy protected data and/or other sensitive data exposure by chatbots. In one example, service provider server 110 may be provided by PAYPAL®, Inc. of San Jose, CA, USA. However, in other embodiments, service provider server 110 may be maintained by or include another type of service provider.

Service provider server 110 of FIG. 1 includes a privacy bot platform 120, service applications 112, a database 114, and a network interface component 116. Privacy bot platform 120, service applications 112, and other applications on service provider server 110 may correspond to executable processes, procedures, and/or applications with associated hardware. In other embodiments, service provider server 110 may include additional or different modules having specialized hardware and/or software as required.

Privacy bot platform 120 may correspond to one or more processes and/or modules associated specialized hardware of service provider server 110 to provide a platform and framework to train, configure, instantiate, and use privacy bots 122 that may be used for detection of exposure of privacy protected data by other chatbots and chatbot systems. In this regard, privacy bot platform 120 may correspond to specialized hardware and/or software used by service provider server 110 to allow for generating the conversational questions, statements, and/or dialogs that attempt to elicit responses having privacy protected data to determine whether that data may be exposed, shared, or leaked by chatbots during automated chat sessions and dialogs through privacy data leaks 125. Privacy bots 122 include a bot AI 123 that may be trained in order to submit questions and/or commands to other chatbots, which may be done in privacy bot chats 124 through an application or website interface or through a “headless browsers” implementation where an open interface browser or application session is not required and the questions and/or commands may be issued via API calls and/or requests. As such, privacy bot chats 124 may correspond to a subset of chats and dialogues from chat sessions 136 between privacy bots 122 and chatbot 132, and may further include other chats for chat sessions with other chatbots that are tested for privacy protected data leakage and/or unauthorized sharing.

As such, privacy bot chats 124 may include a dialog, conversation, exchanged messages, or the like by privacy bots 122 with other chatbots including chatbot 132 hosted, deployed, or otherwise provided by chatbot server 130. Privacy bot chats 124 may be a dialog in an interface and/or exchanged API calls. Based on parsing and/or analyzing a response from the other chatbots, privacy data leaks 125 may be identified, which may correspond to leaks or exposure of private data expected to be kept confidential and/or require user approval for review. Generation of bot AI 123 may be performed by a bot AI trainer 126 using a conversational AI platform, engine, and/or model(s), which may be internal and/or external to service provider server 110. For example, privacy bot platform 120 may utilize ML and/or deep NN (DNN) models, such as a conversational and/or generative AI, large language models (LLMs), and the like for speech, text question, query, or command, and/or conversational dialog generation based on training data 127. Training data 127 may include aggregated regulations 128 from one or more regulatory, legal, and/or company policy resources.

In this regard, aggregated regulations 128 may be determined, collected, generated, and/or otherwise aggregated into a collection of data, corpora of documents, or the like from data resources, whether online (e.g., an online data repository, website, or other resource) from third-parties or offline from user input. Aggregated regulations 128 may be domain-specific and require and/or have aggregated domain-specific knowledge of a particular domain, such as transaction processing, accounts, financial data, PII data, geolocation and/or location discovery, service assistance type, or other particular domain that a chatbot is configured to aid with and/or provide a communication service in, and therefore be governed by that domain's rules, laws, and/or regulations for uses of user data including privacy protected data. As such, aggregated regulations 128 may be aggregated and/or partitioned by domain. However, aggregated regulations 128 may not need to be domain-specific knowledge and may be more general and/or cross-domain applicable. Aggregated regulations 128 may be collected from data privacy requirements for the particular domain and/or laws, rules, and/or regulations governing use of user and/or privacy protected data and/or use of the chatbot (e.g., in specific regions, countries, etc.). Aggregated regulations 128 may also include business rules associated with the domain, chatbot, and/or communication service. In some embodiments, aggregated regulations 128 may correspond to general data protection regulation (GDPR) law, which may govern privacy protected data use and/or communication in an email channel, a text message channel, a push notification channel, or an instant message channel. Training data 127 may include other data, such as chat session parameters of different chat sessions (e.g., fields, commands, capabilities, and the like for conversing with a chatbot), APIs and API call structures, and other data usable to elicit responses from chatbots.

As such, bot AI trainer 126 may train one or more AI or ML models, NNs, conversational AIs, or the like. These models and/or networks may have trained layers based on training data and selected ML features or variables configured to generate conversation or dialog having questions, queries, or commands for privacy protected data, and identify such data when the privacy protected data is exposed using aggregated regulations 128. The ML models and/or NNs of bot AI 123 may initially be trained using training data 127 corresponding to features or variables selected for training of the ML models and/or NNs. For example, ML features or variables may correspond to individual pieces, properties, characteristics, or other inputs for an ML model and may be used to cause an output by that ML model once the ML model has been trained using data for those features from training data. ML models may be used for computation and calculation of model scores based on ML layers that are trained and optimized. As such, ML models may be trained to provide a predictive output, such as a score, likelihood, probability, or decision, associated with a particular prediction, classification, or categorization.

For example, ML models and/or NNs may include DNNs, MLs, LLMs, generative AIs, or other AI models trained using training data having data records that have columns or other data representations and stored data values (e.g., in rows for the data tables having feature columns) for the features. When building ML models and/or NNs, training data may be used to generate one or more classifiers and provide recommendations, predictions, or other outputs based on those classifications and an ML or NN model algorithm and architecture. Such determinations may be used with privacy bots 122 during the provision of computing services for detection of leaks, shares, or other exposures of privacy protected data.

The algorithm and architecture for the ML models and/or NNs may correspond to DNNs, ML decision trees and/or clustering, conversational AIs, LLMs, generative AI, and other types of AI, ML, and/or NN architectures. The training data may be used to determine features, such as through feature extraction and feature selection using the input training data. For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when the ML models and/or NNs are used to perform a predictive analysis and output, the input data may provide a corresponding output based on the trained classifications.

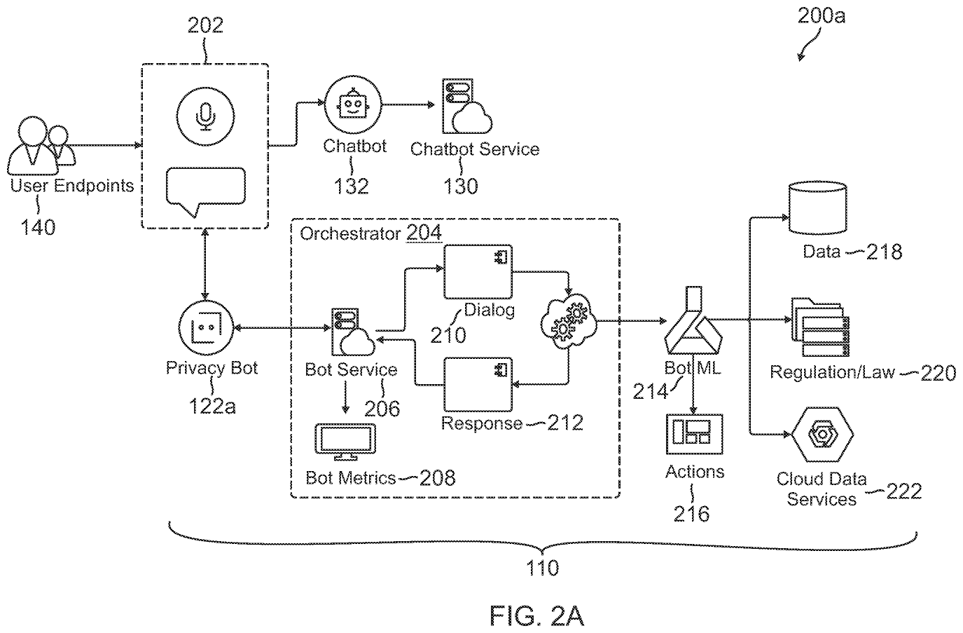

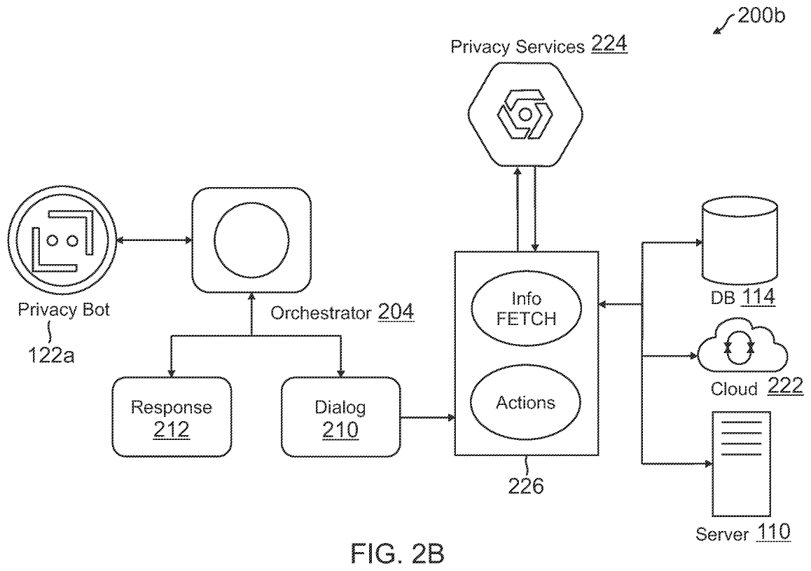

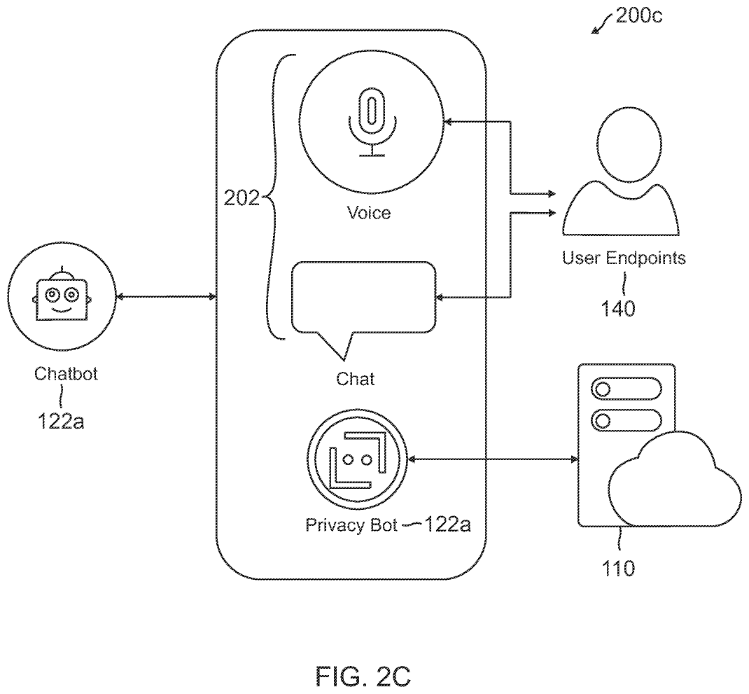

Layers, branches, clusters, or the like of the ML models and/or NNs may be trained by using training data 127 associated with data records for aggregated regulations 128 and a feature extraction of training features from the data records. By providing training data, the nodes in the hidden layer may be trained (adjusted) such that an optimal output (e.g., a classification) is produced in the output layer based on the training data. By continuously providing different sets of training data and/or penalizing the ML models and/or NNs when the outputs are incorrect, the ML models and/or NNs (and specifically, the representations of the nodes in the hidden layer) may be trained (adjusted) to improve its performance in data classifications and predictions. Adjusting of the ML models and/or NNs may include adjusting the weights associated with each node in the hidden layer. Privacy bot platform 120 may instantiate and/or use privacy bots 122 once bot AI 123 is generated and/or trained by bot AI trainer 126, which may be used to communicate with other chatbots through privacy bot chats 124 and detect privacy data leaks 125. Detection of privacy data leaks 125 in privacy bot chats 124 is discussed further herein with respect to FIGS. 2A-5 below.

Service applications 112 may correspond to one or more processes to execute modules and associated specialized hardware of service provider server 110 to process a transaction and/or provide other computing services to users. For example, service applications 112 may be used to process payments and other services to one or more users, merchants, and/or other entities for transactions, who may require assistance prior to, during, or after transaction processing through internal and/or external chatbots that are monitored for privacy data leaks 125 by privacy bots 122 of privacy bot platform 120. In this regard, service applications 112 may correspond to specialized hardware and/or software used by a user to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 110. The financial information may also be used to establish a payment account and provide payments through the payment account.

The payment account may be accessed and/or used through a browser application and/or dedicated payment application. Service applications 112 may be used to process a transaction, such as using an application/website or at a physical merchant location. In some embodiments, service applications 112 may further be used to provide rewards, incentives, benefits, and/or portions of a cost or price of a transaction based on the transaction being processed for a purchasable item. Service applications 112 may process the payment and may provide a transaction history for transaction authorization, approval, or denial. However, in other situations, service applications 112 may instead provide different computing services, including social networking, microblogging, media sharing, messaging, business and consumer platforms, etc. These computing services may be used by customers and users, such as through user devices 140, and therefore those customers and users may receive assistance through chatbots.

Service applications 112 as may provide additional features to service provider server 110. For example, service applications 112 may include security applications for implementing server-side security features, programmatic client applications for interfacing with appropriate application programming interfaces (APIs) over network 150, or other types of applications. Service applications 112 may contain software programs, executable by a processor, including one or more GUIs and the like, configured to provide an interface to the user when accessing service provider server 110, where the user or other users may interact with the GUI to view and communicate information more easily. Service applications 112 may include additional connection and/or communication applications, which may be utilized to communicate information to over network 150.

Additionally, service provider server 110 includes database 114. Database 114 may store various identifiers associated with user devices 140. Database 114 may also store account data, including payment instruments and authentication credentials, as well as transaction processing histories and data for processed transactions. Database 114 may store financial information and tokenization data, as well as transactions, transaction results, and other data generated and stored by service applications 112. Although database 114 is shown as residing on service provider server 110 as a database, in other embodiments, other types of data storage and components may be used including cloud computing storage nodes, remote data stores and database systems, distributed database systems over network 150 and/or of a computing system associated with service provider server 110, and the like.

Service provider server 110 may include at least one network interface component 116 adapted to communicate chatbot server 130, user devices 140 and/or other devices, servers, and the like directly and/or over network 150. In various embodiments, network interface component 116 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Server 180 including chatbot server 130 may be maintained, for example, by an online service provider, which may provide a platform in which privacy protected data 138 is generated, stored, and/or utilized, such as in the process of providing a computing service to users and/or a service or product associated with privacy protected data 138 (e.g., a financial institution, credit card company, credit agency, healthcare provider, etc.). As such, chatbot server 130 may provide automated operations for conversing with internal and/or external customers or other end users of service provider server 110. In this regard, chatbot 132 includes one or more processing applications, which may be configured to interact with service provider server 110 and/or user devices 140 to provide communication service 134 that enables automated chat responses, assistance, and the like through chat sessions 136 data based on a conversational AI and corresponding user data that may include privacy protected data 138.

Chatbot server 130 may be selected to test and query for leakage or unauthorized sharing of privacy protected data 138 based on a use of chatbot server 130 for communication service 134, such as to provide chatbot services to customers of service provider server 110. Privacy protected data 138 may be accessible by chatbot server 130 and/or chatbot 132, such as during the use of chatbot 132 for chat sessions 136 with privacy bots 122, user device 140, and/or other applications, devices, and/or servers. Privacy protected data 138 is shown as residing on a server of the service provider providing chatbot server 130, such as within the databases or other data storage structure of a server system or computing environment of the service provider. However, in other embodiments, privacy protected data 138 may reside elsewhere and/or from a remote server and/or data storage including from cloud computing storages and/or remote or distributed database systems. In some embodiments, chatbot server 130 may provide communication service 134 on behalf of service provider server 110 and/or in association with service applications 112, such as to provide automated chatbot communication services to customers of service provider server 110. As such, privacy protected data 138 may be associated with customers and/or other data of service provider server 110 and/or server 180.

However, in other embodiments, chatbot server 130 may not be associated with computing service provided by service provider server 110. In such embodiments, service provider server 110 may select chatbot server to test and query based on a list of chatbots for testing, an enrollment or onboarding of chatbot 132 for testing by service provider server 110 (e.g., where privacy protection testing of chats is provided as a service by service provider server 110), a report of chatbots that leak data or are vulnerable to data leakage, where privacy protected data 138 may be provided by and/or protected by service provider server 110 (e.g., where service provider server 110 has an obligation, either by law, regulation, compliance requirement, or agreement to protect privacy protected data), or other designated of chatbot 132 for testing by privacy bots 122. In some embodiments, privacy bot platform 120 may also crawl a registry or online webpages and resources for chatbots to test, thereby identifying chatbot server 130. In t

Chatbot 132 may be executed by a chat automation and/or AI, which may correspond to the hardware and/or software of chatbot server 130. The chat automation of chatbot 132 may correspond to a computing automation process or device that implements one or more conversational AI models, flows, dialogs, or the like that converses with users, as well as privacy bots 122. In this regard, chatbots 132 may be used in chat sessions 136 corresponding to the different chats and dialogues occurring between real and automated endpoints and entities. These may include other automated chatbots, such as privacy bots 122, where a portion of chat sessions 136 may be associated with privacy bot chats 124 that occur between privacy bots 122 and chatbot 132 that test or query chatbot 132 for leaks or unauthorized sharing and disclosure of privacy protected data 138 accessible to chatbot 132 from chatbot server 130. For conversation and/or dialog in chat sessions 136, user data may be shared, which may include privacy protected data 138. As such, privacy bots 122 may be employed to detect privacy data leaks 125 including those by chatbot 132, which may allow for remediation and fixing to prevent exploits. In one example, service provider server 110 and chatbot server 130 may be separate and distinct entities, where privacy bot platform 120 may interact with chatbot 132 through privacy bots 122 over network 150 through chat sessions for chat sessions 136 in browser or application interfaces, as well as direct API calls and requests through a headless browser implement.

When chatbot 132 is instantiated for chat sessions 136, chat sessions 136 may occur with different endpoints including real users via user devices 140, as well as automated chatbots and the like including privacy bots 122 that test chatbot 132 via queries, statements, and the like to detect any leakages and/or unauthorized sharing of privacy protected data 138. In this regard, chat sessions 136 may correspond to different chats, dialogues, and conversations, where a subset of those chats may correspond to privacy bot chats 124 with privacy bots 122, as well as another subset corresponding to user chats 142 with the users for user devices 140. As such, chat sessions 136 may include privacy bot chats 124 that include queries or statements by privacy bots 122 in an attempt to elicit revelations of privacy protected data 138, with corresponding responses by chatbot 132.

Service provider server 110 and/or chatbot server 130 may be provided by the same entity and/or may be similarly controlled (e.g., both service provider server 110 and chatbot server 130 may be provided by PAYPAL®, Inc. of San Jose, CA, USA or other transaction processor and/or service provider), and therefore privacy bots 122 and/or chatbot 132 may communicate directly, over a local network, or the like. However, in other embodiments, service provider server 110 may be provided as a separate entity that may regulate, protect, and/or enforce data privacy laws, rules, regulations, and the like with different providers of chatbots. For example, service provider server 110 may correspond to a governmental and/or regulatory agency that may test chatbots for data leakage to enforce protections of data privacy within a region, jurisdiction, or the like. Service provider server 110 may also correspond to a separate entity that may be used by (e.g., onboarded and/or opted in for chatbot testing) chatbot providers for testing chatbots and/or may independently crawl online websites and/or resources for available chatbots to test.

User devices 140 may be implemented as communication devices or other endpoints that may utilize appropriate hardware and software configured for wired and/or wireless communication with service provider server 110 and/or chatbot server 130. As such, user devices 140 may be utilized by users, which may include customers and other end users, merchants, or other persons or entities that may interact with chatbot server 130 to receive automated chat and communication services via chatbot 132. For example, one or more of user devices 140 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data.

In this regard, user devices 140 may be used to access a website or portal via user interfaces provided by chatbot server 130 to request automated chat assistance from chatbot 132 through user chats 142. User chats 142 may correspond to a subset or portion of chat sessions 136 that occur between chatbot 132 and user devices 140. The conversational AI and workflow of chatbot 132 may provide the skill(s) that enable self-service and automated assistance to users without requiring, or requiring minimal, live agent assistance, thereby providing responses and information through automated chatbot AI and dialog. For example, conversational chatbot interactions may be provided for user chats 142 in different communication channels for automated assistance options and workflows to perform some task, including account setup and maintenance, password reset or other authentication, electronic transaction processing issues and assistance, and the like that may be associated with an online transaction processor. However, other service providers may provide different services. During conversing with users, exchanged chat data 144 may correspond to conversational exchanges that occur between users and chatbots, such as by users providing text, audio, or other conversational data and/or chatbots responding when conversing with users. However, exchanged chat data 144 may include privacy protected data. As such, privacy bots 122 may be used by service provider server 110 to assist with prevention of privacy protected data from being exposed to the wrong or incorrect party, thereby minimizing impact by malicious parties on chatbot systems from exploits and the like.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100a.

In FIG. 1B, system 100b shows a more granular block diagram of the corresponding interactions and instantiated chat sessions, dialogs, and communications between privacy protection chatbots and other chatbots for chat and communication services. In system 100b, privacy protection chatbots 122a and 122b is hosted by a privacy bot platform 120. Privacy bot platform 120 communicates, via privacy protection chatbot 122a, with chat sessions 136 for chatbot 132. Similarly, privacy bot platform 120 communications, via protection chatbot 122b, with chat sessions 176 for a chatbot 172 hosted by a server 170 that has access to and/or may utilize privacy protected data 174. As discussed in system 100a of FIG. 1A, chatbot 132 is hosted by chatbot server 130 to provide communication service 134 via chat sessions 136. In system 100a, server 180 includes chatbot server 130 (not shown, which may reside internally or externally as a third-party service and/or external server) and privacy protected data 138, which is utilized by chatbot 132 as shown in system 100b. Chatbot 132 communicates via chat sessions 136 with various applications, devices, servers, and/or other endpoints. Chat instance(s) 142a from user device 140a can communicate with other chat application instances (not shown) for chatbot 132 via chat sessions 136. For example, chat instance(s) 142a may correspond to one or more of user chats 142 where users converse with chatbot 132, and chat instance(s) 142a can transmit a chat text to the chat sessions 136, where this chat text can be accessed by other chat application instance(s).

Privacy protection chatbot 122a and chatbot 132 can each simulate a respective chat application instance when communicating with each other. Similarly, privacy protection chatbot 122b and chatbot 172 may simulate a respective chat application instance, and thus, privacy protection chatbots 122a and 122b may each be instantiated for corresponding communications and chat application instances with chatbots 132 and 172, respectively. As such, privacy bot platform 120 of service provider server 110 may instantiate different, separate, and multiple instances of privacy bots 122 (e.g., privacy protection chatbots 122a and 122b) for separate sessions to detect leakage of privacy protected data 138 and 174 by chatbots 132 and 172, respectively. Chat instance(s) 142a may be hosted by a user device 140a. where user device 140a can also display a user interface (UI) 146. UI 146 can display visual elements, such as chat texts of the chat sessions 136. UI 146 can also receive input from a user, such as a selection via user device 140a. It is noted that the user device 140a can also receive input from a user via other input elements, such as via a keyboard, mouse, microphone (e.g., from a voice command), among others.

Privacy bot platform 120 can interface with a service provider server 110 to receive instructions from and/or provide data (e.g., responses, which may include user data and/or privacy protected data 138) to service provider server 110. Service provider server 110 can provide privacy protection services for detection of privacy protected data exposures and implementation of safeguards or other remedial measures to prevent privacy protected data leakage, sharing, and/or exposure by chatbots 132 and 172. Service provider server 110 may further provide financial services, such as a fund transfer (e.g., a transfer of a certain monetary amount), to users. Service provider server 110 can include payment accounts, each of which can be associated with a user. For example, a user of the user device 140a can be associated with a user payment account, and a merchant can be associated with a merchant payment account at the service provider server 110. Service provider server 110 can facilitate the fund transfer from the user payment account to the merchant payment account. Service provider server 110 can be implemented by PAYPAL® or another online payment system that allows users to send, accept, and request fund transfers.

In the example illustrated in FIG. 1B, service provider server 110 interfaces with one or more regulatory, legal, financial, compliance, and/or other institutions for provision of laws, rules, regulations, guidelines, policies, or the like for privacy requirements or standards with regard to protection of data (e.g., types of data to prevent exposure by sharing, leaking, or the like), such as regulatory institutions 160. Regulatory institutions 160 can provide requirements, standards, and/or practices for the protection of privacy protected or controlled data. Regulatory institutions 160 can be implemented as regulatory or legal institutions, banks, large data stores and/or handlers, other service providers, governmental resources, and the like.

In one embodiment, privacy bot platform 120 can be implemented as a part of the service provider server 110. The server can be implemented on a single computing device, or on multiple computing devices (e.g., using distributed computing devices or a cloud service). In another embodiment, privacy bot platform 120 is separate from the service provider server 110. The privacy bot platform 120 can instantiate privacy protection chatbots 122a and 122b, as well as other chatbots. Privacy protection chatbots 122a and 122b in system 100b may each correspond to one of privacy bots 122 from system 100a, such as a single instance, application, or bot program of an AI chatbot that detects leakage or unauthorized sharing of privacy protected data 138. Privacy bot platform 120 can access, via the privacy protection chatbot 122a, chat texts that are provided to chat sessions 136 by chat instance(s) 142a and/or by communication service 134, as well as corresponding chat texts and dialogues for chat sessions 176 from chatbot 172. Privacy bot platform 120 can determine, for example, whether any of privacy protected data 138 or 174 is present, indicated, or otherwise exposed by the chat text. Depending on the content of the chat text, the privacy bot platform 120 can transmit, via privacy protection chatbots 122a and 122b, another chat text to chatbots 132 and/or 172, or communicate with service provider server 110, to hide, prevent exposure of, remediate exposure of, end communications, alert of exposure of, or otherwise perform remedial actions for privacy protected data 138 and/or 174 that was exposed.

A service or an application (such as privacy bot platform 120) can be hosted by a combination of software and hardware. It is noted that the same term “hosting” is used herein to describe both software hosting and hardware hosting. When software hosting, a software service can instantiate and manage multiple chat sessions, such as the chat sessions 136 and other chat sessions. When hardware hosting, a computing device (such as a server or a user device) can provide resources such as memory, communication, and execution resources for execution of instructions.

In some implementations, the user associated with chat instance(s) 142a does not have a direct way to access service provider server 110 and/or view exposures of privacy protected data 138. For example, the user may only have access to chat sessions 136 via chat instance(s) 142a. For frictionless operation, service provider server 110 allows the user to receive indications of whether privacy protected data 138 and 174 is exposed or was exposed via user interaction with the chat instance(s) 142a or other users' interactions (e.g., malicious or fraudulent actors). Privacy bot platform 120 can access, via the privacy protection chatbot 122a, chat texts in chat sessions 136. The chat text(s) can be provided to chat sessions 136 from chat instance(s) 142a. Privacy bot platform 120 can access (via the privacy protection chatbot 122a) a chat text provided to chat sessions 136 by communication service 134 (via the chatbot 132). Similarly, privacy bot platform 120 can access, via privacy protection chatbot 122b, chat text provided to chat sessions 176 by chatbot 172 when hosted by server 170 (which may include an internal chatbot server similar to chatbot server 130 or be associated with an external and/or third-party chatbot server). The chat text may have corresponding chat session parameters and/or dialog, communications, and/or messaging, such as a text or chat window format, chat commands and interactions, communications by or with chatbots 132 and 172, and the like.

Using these chat session parameters and/or chat dialog and communications, privacy protection chatbots 122a and 122b may issue questions, queries, or statements designed to elicit responses that may include privacy protected data 138 and 174, such as a question for user data that may include privacy protected data 138 and 174 that should not be exposed. As such, privacy protection chatbots 122a and 122b may then detect whether privacy protected data 138 and 174 is leaked or shared without proper permissions or authorizations, such as from previous user authentications and/or verifications. Privacy bot platform 120 can access chat texts for chat sessions with privacy protection chatbots 122a and 122b. Based on the chat text(s), privacy bot platform 120 can determine dialog and/or other conversational flow that tests chatbots 132 and 172 for revelations of privacy protected data 138 and 174. In some embodiments, service provider server 110 can receive a session request from, issue requests or calls to, and/or otherwise communicate with chatbot server 130 and/or server 170 without requiring an active interface of a chat session, such as via API calls through a headless browser implementation.

FIGS. 2A-2C are exemplary system architectures 200a-200c including a privacy protection chatbot interacting with other chatbot systems to identify and protect from exposures of privacy protected data by the other chatbot systems, according to an embodiment. System architectures 200a-200c may include components referenced with regard to systems 100a and 100b of FIGS. 1A and 1B, respectively, such as the components of service provider server 110 and chatbot server 130 interacting over network 150. In this regard, system architectures 200a-200c show representations of privacy protection chatbot 122a interacting with chatbot 132 of chatbot server 130 for providing identification of exposure of privacy protected data.

In system architecture 200a, an environment and/or system ecosystem for training, instantiating, and using privacy protection chatbot 122a is shown. In this regard, chatbot server 130 may access privacy protected data 138 and host or otherwise provide chatbot 132 that may converse with user devices 140 in an automated manner and/or be tested and queried by privacy bots 122 for any leakage or unauthorized sharing of privacy protected data. For example, chatbot server 130 may instantiate chatbot 132 for chat sessions 202 with user devices 140 and/or privacy protection chatbot 122a when requested to provide a conversational AI and/or automated conversation and dialog for a communication service. In order to detect leaks or incidental shares of privacy protected data 138, privacy protection chatbot 122a may be instantiated for chat sessions 202 by an orchestrator, which may correspond to an application and/or orchestration layer of service provider server 110 or other online digital platform providing privacy protection chatbot 122a for use and data security. Orchestrator 204 may be used to orchestrate chatbot services and privacy protection of data through detection of exposures of privacy protected data. In this regard, orchestrator 204 includes a bot service 206 to instantiate privacy protection chatbot 122a on command and/or when requested for privacy protection services and data security.

Orchestrator 204 further provides additional services and operations to facilitate use of privacy protection chatbot 122a by bot service 206. For example, bot service 206 may capture bot metrics 208 for tracking of privacy protection chatbot 122a and use in questions other chatbots, responding to dialog, and/or tuning further use of privacy protection chatbot 122a. For example, bot metrics 208 may be used to show details about privacy rules applied to conversations and chat sessions, usage and/or exposure of privacy protected data, scores for data security and/or privacy protection based on data exposure, and the like.

Bot service 206 may generate dialog 210 and process a response 212 using a bot ML 214 trained to detect exposures of privacy protected data using historical data, conversational and/or generative AI for human-like communications, and other laws, rules, regulations, standards, or the like for protecting and/or use of privacy protected data. For example, dialog 210 may be generated from a conversational AI feature of bot ML 214 and may include questions or the like to query and/or submit to chatbot 132 by privacy protection chatbot 122a during chat sessions 202. As such, privacy protection chatbot 122a may start a conversation with chatbot 132 in chat sessions 202 as a normal customer that attempts to gain access to privacy protected data. Chatbot 132 may respond with response 212, which may be parsed, processed, and/or analyzed to detect exposure of privacy protected data.

Bot ML 214 may be trained and configured for use by bot service 206 during dialog 210 and response 212 for processing, as well as other conversational AI activities and actions. In this regard, bot ML 214 may correspond to an ML program that generates privacy related questions, which may be converted to text to apply to chat sessions 202 and used when executing API calls for responses. Bot ML 214 may perform actions 216 for determination and/or discovery of privacy violations based on privacy protected data exposure, as well as corresponding remedial or notification actions to take with regard to the privacy violations. Bot ML 214 may be trained using data 218, such as customer sample data for ML model training of conversational dialog and/or questions that did or didn't elicit responses with privacy protected data and regulations/law 220 for privacy regulations and laws used to generate questions for privacy protected data. Bot ML 214 may also be maintained by cloud data services 222 for a cloud service that trains, maintains, and/or updates bot ML 214 for use by different computing systems.

Referring to FIG. 2B, in system architecture 200b, a design of privacy protection chatbot 122a and corresponding application is shown in further detail. For example, privacy protection chatbot 122a is connected with orchestrator 204 that generates dialog 210 for use in chat sessions 202 and processes response 212. In order to generate and process dialog 210, privacy services 224 may provide an ML engine 226 that processes information (e.g., dialog 210, chat session parameters, chatbot domain, etc.) to determine different actions to take and/or perform. For ML engine 226 to make decisions and/or determine actions (e.g., questions for privacy protected data) during runtime after instantiation of privacy protection chatbot 122a for a chat session, ML engine may fetch information from service provider server 110, database 114, and/or cloud data services 222.

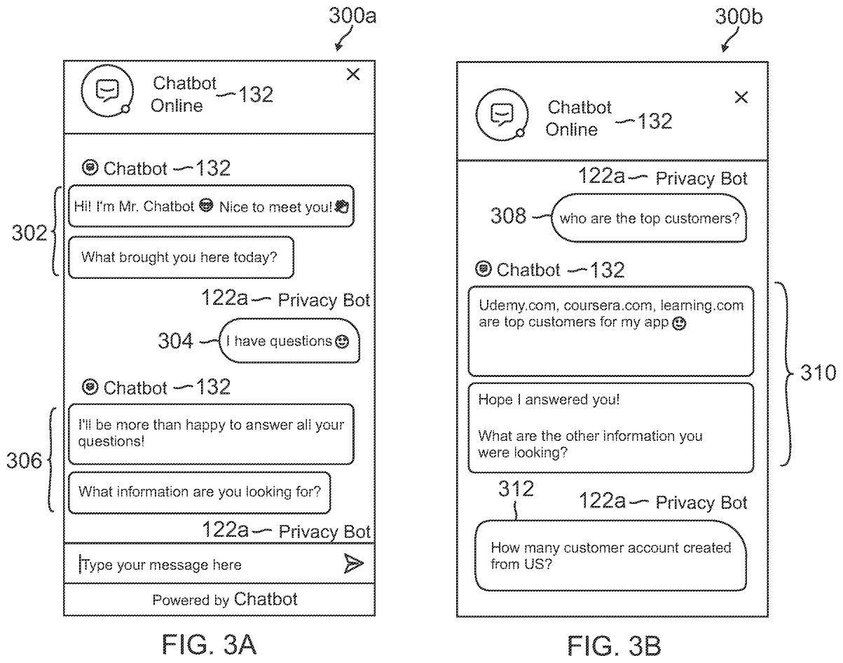

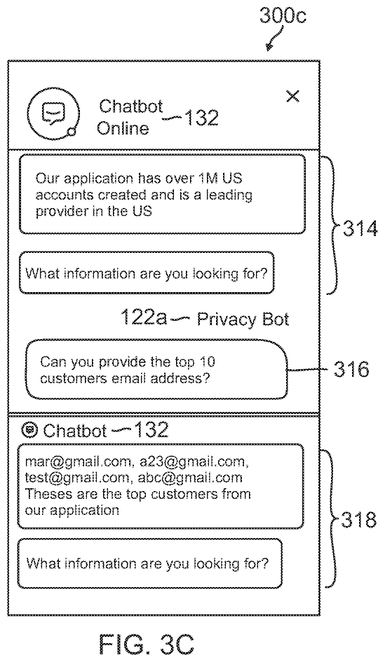

Referring to FIG. 2C, in system architecture 200c, an implementation of privacy protection chatbot 122a to communicate with chatbot 132 through chat sessions 202 is shown. Chatbot 132 may be provided by a chat application and/or platform that provides communication services to users at user devices 140, such as to provide automated assistance and other conversational services. In this regard, chatbot 132 may be provided in different communication channels, shown as voice (e.g., interactive voice response systems, automated phone or voice systems, etc.) and chat, via chat sessions 202. Further, privacy protection chatbot 122a may be used to communicate with chatbot 132 in chat sessions 202, which may be used to submit questions to chatbot 132 by privacy protection chatbot 122a and request privacy protected data to detect if such data may be exposed or leaked without authorization. As such, service provider server 110 may instantiate privacy protection chatbot 122a for use with chat sessions 202 to provide questions designed to elicit responses with privacy protected data in chat sessions 202, as shown in the communications, conversations, and/or dialog shown in FIGS. 3A-3C below.

FIGS. 3A-3C are exemplary user interfaces 300a-300c of chat sessions between a privacy protection chatbot and a chatbot system to detect whether privacy data is exposed during chat sessions and other communications, according to an embodiment. User interfaces 300a-300c of FIGS. 3A-3C include a chat session displayed by a computing device, such as a machine of service provider server 110 from system 100a of FIG. 1A. As such, privacy protection chatbot 122a and chatbot 132 may converse in interfaces 300a-300c during a chat session, where privacy protection chatbot 122a may test chatbot 132 for exposure of privacy protected data. However, it is understood that an open interface or window is not necessarily required to communicate with a chatbot, and direct API calls and data exchanges may be used without open interfaces and/or windows.

In interface 300a, after a connection with chatbot 132, chatbot 132 may initially transmit greeting messages 302, which can be an initial greeting and/or general sign of recognition by chatbot 132 of establishment of the chat session and connection. This may prompt privacy protection chatbot 122a to respond to chatbot 132 with questions in a priming message 304, which alerts chatbot 132 of such pending questions. In this regard, privacy protection chatbot 122a may provide priming message 304 to determine that privacy protection chatbot 122a is properly configured and able to utilize chat session parameters to converse with chatbot 132. As such, when chatbot 132 responds with acknowledgement messages 306, privacy protection chatbot 122a is notified that it may begin the process to query or otherwise issue and/or provide questions or statements to chatbot 132 in an attempt to elicit responses with privacy protected data to identify security breaches and/or issues that may need addressing before exploitation by malicious parties.

In interface 300b, privacy protection chatbot 122a then asks a first question 308, which may be generated by an ML model and/or engine based on laws, regulations, and rules that govern use of chatbot 132 and/or user data used by chatbot 132 to label privacy protected data that is protected from use and/or disclosure to users and other entities without proper authorization and/or verification. As such, first question 308 may correspond to a general, high-level question that is designated to obtain user data that may include privacy protected data as designated by the laws, regulations and/or rules, as well as other requirements or standards for the entity providing and using chatbot 132. Chatbot 132 then responds with a first response 310, which identifies certain parties and/or entities. This may or may not be privacy protected, and as such, the ML model and/or engine for privacy protection chatbot 122a may process first response 310 to identify whether first response 310 complies or violates the applicable laws, regulations, and/or rules used to train the ML model. To detect any further privacy protected data leaks, privacy protection chatbot 122a may then provide a second question 312 in the chat session. Second question 312 provides a finer level of detail, and may or may not be customer-specific that requires customer-specific information when querying and/or responding.

In interface 300c, chatbot 132 then responds with a second response 314. In a similar manner, the ML model may process second response 314 to identify any exposure of privacy protected data that privacy protection chatbot 122a is not authorized to access and/or receive. Thereafter, privacy protection chatbot 122a may ask a third question 316, which may be more granular and based on previously asked first question 308 and/or second question 312, as well as receiving first response 310 and second response 314. Third question 316 may further be based on customer-specific information (e.g., a username, address, financial instrument, location, email address, etc., which may be real or faked for third question 316), or may be general based on the ML engine's training and laws, regulations, and/or rules that are applicable. Thereafter, chatbot 132 may respond with third response 318, which may be parsed for any exposure of privacy protected data.

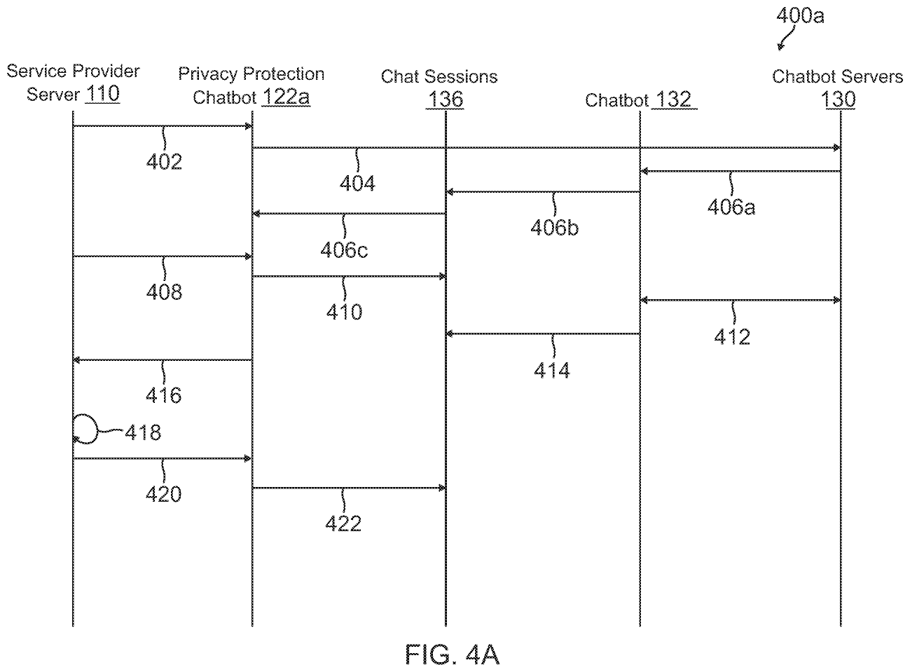

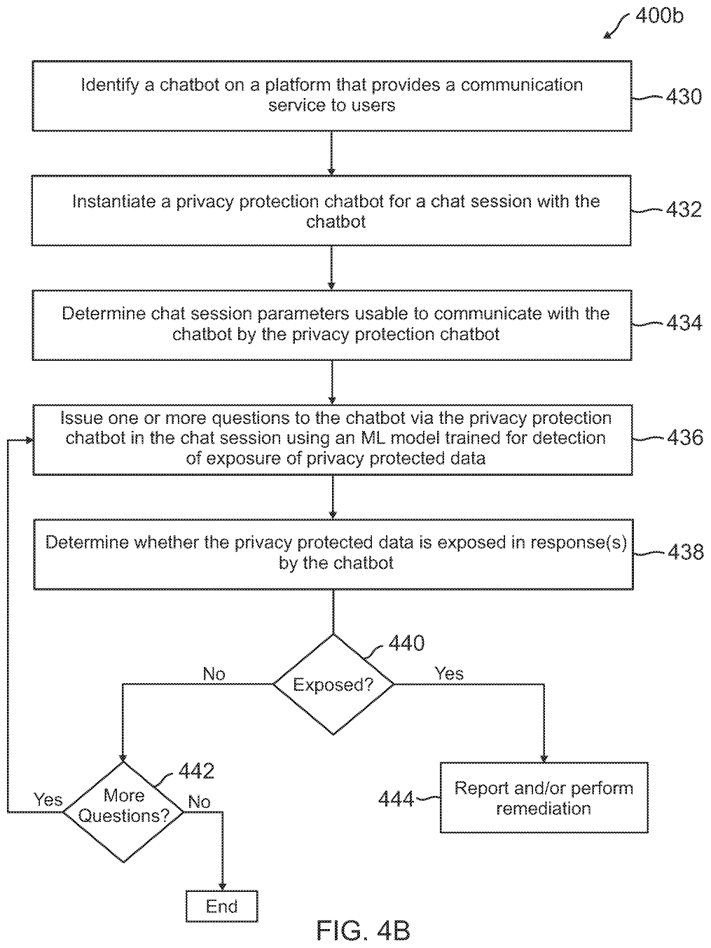

FIG. 4A is an exemplary diagram 400a of interactions between a service provider server that provides a privacy protection chatbot and another chatbot server that provides a chatbot that is monitored to detect whether privacy data is exposed during use, according to an embodiment. Diagram 400a represents an exchange of calls between systems when instantiating a chat session where bots may interact to exchange data between different applications in an automated manner. As such, diagram 400a includes service provider server 110, privacy protection chatbot 122a, chatbot server 130, chatbot 132, and chat session(s) 126a, as discussed in reference to system 100a and 100b of FIGS. 1A and 1B, respectively.

Initially, at a step 402, service provider server 110 instantiates, creates an instance of, or otherwise starts and causes execution of privacy protection chatbot 122a, such as using a corresponding application and/or platform. For example, service provider server 110 may instantiate privacy protection chatbot 122a in order to test chatbot 132 via chat sessions 136 for leaking or unauthorized sharing of privacy protected data. Instantiation may occur prior to creation of a new one of chat sessions 136 for querying or conversing with chatbot 132 to perform the testing, or an existing one of chat sessions 136 may be awaiting instantiation and connection of privacy protection chatbot 122a for chats between

Once an instance of privacy protection chatbot 122a is running, privacy protection chatbot 122a may connect with chatbot server 130, at step 404, which may be used to connect privacy protection chatbot 122a with a new or existing one of chat sessions 136 for conversing with chatbot 132. When establishing the connection at step 404, service provider server 110 and/or privacy protection chatbot 122a may identify a chatbot service that provides a communication service to users through automated communications in one or more communication channels. Use of such communication services may risk malicious parties compromising the automated chatbot systems and protections from revealing privacy protected data. As such, on identification of such services and chatbots, privacy protection chatbot 122a may be instantiated to test for weakness and/or vulnerabilities to exposure of such data.

At steps 406a-406c, a chat session is created, or an existing chat session is connected to, based on instantiating privacy protection chatbot 122a for such session and communications with chatbot 132. For example, on instantiation of privacy protection chatbot 122a, the established connection from step 404 may be used for communications via chat sessions 136 with chatbot 132. As such, chatbot server 130 may instantiate and/or create an instance of chatbot 132 at step 406a, which may then open or create one of chat sessions 136 at step 406b for conversing with privacy protection chatbot 122a. At step 406c, the corresponding one of chat sessions 136 is then connected with privacy protection chatbot 122a.

At step 408, service provider server 110 and privacy protection chatbot 122a then generate, create, and/or formulate one or more questions for chatbot 132 designed to obtain a response that may include privacy protected data. The question or other statement may be generated using an ML model and may correspond to a high-level general question, such as a generic question for a username or address, or may correspond to more granular customer-specific and/or customer information-specific questions that may target a real or imitated customer or other user that may interact with chatbot 132. Further, the question(s) may be generated using domain-specific knowledge of the particular domain for the communication service being provided by chatbot 132.

At step 410, the question is then provided in the corresponding one of chat sessions 136, such as by entering text, audio, or other communications to the chat session in the corresponding communication channel. Chatbot 132 and chatbot server 130 then interact at step 412 to process the question(s) and determine one or more response(s) that may utilize user data including privacy protected data as a basis for the response. The response(s) are then provided by chatbot 132 to chat sessions 136 for reading, parsing, and/or analyzing by privacy protection chatbot 122a, at step 414, which may be provided in the corresponding one of chat sessions 136. Communications during steps 410 and 414 in chat sessions 136 may be performed through an open interface and/or window for the chat session, or may be done through exchanged API calls without specific requirements of having an open window/interface for chat input in the chat session, such as in a headless browser implementation for conversing between automated systems. Further, privacy protection chatbot 122a may use a conversational AI system for the communications that may be determined based on the requirements of chat sessions 136, a language or linguistic requirement, a dialog parameter for conversation in chat sessions 136, one or more communication channels used for chat sessions 136, or another requirement of chat sessions 136.

At step 416, the response is provided back to service provider server 110 by privacy protection chatbot 122a after reading, parsing, and/or analyzing from chat sessions 136. This allows for parsing of the response to identify and determine whether privacy protected data has been exposed. As such, at step 418, service provider server 110 processes the response, such as using the ML model trained for detection of exposure of privacy protected data. A decision is determined, and at step 420, further commands are issued to privacy protection chatbot 122a. This may include further questions, which may be entered to the corresponding one of chat sessions 136 at step 422, or a command to end the chat session or inform chatbot 132 of an incidental exposure for handling.

FIG. 4B is a flowchart 400b for automated chatbots that detect privacy data sharing and leakage by other automated chatbot systems, according to an embodiment. Note that one or more steps, processes, and methods described herein of flowchart 400b may be omitted, performed in a different sequence, or combined as desired or appropriate.

At step 430 of flowchart 400b, a chatbot on a platform that provides a communication service to users is identified. The chatbot may be identified on an internal or external platform of the service provider providing a privacy protection platform and automated chatbot to detect exposures of privacy protected chatbot in other automated computing systems, such as the chatbot on the platform providing the communication service. For example, the communication service may correspond to an assistance service, question and answer bot, automated shopping or purchasing bot, conversational AI (including ChatGPT and the like), or other automation that communicates with users using AI models, rules, and the like. As such, these chatbots may provide user data in response to questions, comments, and the like, where providing user data may risk exposure of privacy protected data when not authorized. As such, identification of these chatbots may allow the systems to be tested to protect from incidental leakage or sharing due to loopholes, oversights, vulnerabilities, and the like in security system implementation and execution.

At step 432, a privacy protection chatbot is instantiated for a chat session with the chatbot. The privacy protection chatbot may correspond to an automation run on a platform and/or provided by an application that may mimic human conversational chat and communications in chat sessions and is capable of issuing or transmitting messages, questions, comments, commands, or other text, audio, or the like that elicits the chatbot providing the communication service to respond. The chat session may be instantiated by creating the chat session in an application and/or browser window or interface that enables communication with the chatbot, such as by opening an interface and entering text to a chat window. However, as the privacy protection chatbot is a corresponding automation, an open window or interface is not required, and API calls may be requested and received through a headless browser implementation.

At step 434, chat session parameters usable to communicate with the chatbot by the privacy protection chatbot are determined. In this regard, chat session parameters may include those associated with a location, language, text or query structure, endpoint identifier, and other relevant data for communicating with the chatbot. Chat session parameters may also be used to determine a domain of the chatbot and/or communication service, which may be used for the specific invocation of the privacy protection bot for knowledge of that domain (e.g., transaction processing assistance, account login or setup, authentication and/or password recovery, medical reporting, court or criminal record reports, etc., which each have regulatory requirements for compliance with laws, regulations, and rules enforced for privacy data). As such, the domain may be used for selection of the questions or commands issued to the chatbot.

At step 436, one or more questions are issued to the chatbot via the privacy protection chatbot in the chat session using an ML model trained for detection of exposure of privacy protected data. The questions may be generated by a conversational AI trained using system policies and/or regulatory information, such as the laws, regulations, and/or rules governing use and/or provision of user data including privacy protected data by agents, real or automated, as well as protection of such data from revelation to unauthorized parties, when conversing with users. For example, different privacy data may have different requirements such as GDPR law for user data in certain countries, Health Insurance Portability and Accountability Act (HIPAA) requirements for health data, and the like. As such, using the laws or other regulations that may be enforced based on company policy or the like, an ML model may be trained to detect when such data is exposed, as well as issue questions and statements designed to elicit specific responses with such data when not authorized.

At step 438, it is determined whether the privacy protected data is exposed in response(s) by the chatbot. The chatbot may receive responses to the questions or other statements provided in the chat session, and may parse, analyze, or otherwise process the responses to identify if privacy protected data is exposed. This may be done using the ML model trained to detect exposures of privacy protected data. The data may be detected when provided back in full in a single response or may be provided back in pieces that are stitched together in multiple responses, and therefore the privacy protection bot may parse and analyze multiple responses to identify if privacy protected data may be exposed (e.g., a last name in one response, an address in another, etc., until full PII information is determined).

If, at step 440, there is a determination that no exposure has occurred, flowchart 400b proceeds to step 442 where it is checked whether there are more questions to ask the chatbot by the privacy protection chatbot. If yes, flowchart 400b returns to step 436 to issue such questions. However, if not, flowchart 400b ends without detection of privacy protected data being exposed. Conversely, if at step 440, there is a determination that an exposure of privacy protected data has occurred, flowchart 400b proceeds to step 444 where the exposure is reported and/or a remediation is performed. For example, the exposure, leak, or vulnerability in the chatbot system and/or conversational AI responses (e.g., with enforcement and/or adherence to data security and privacy laws, rules, regulations, etc.) may be identified and transmitted to a system administrator or other entity managing the chatbot. Further, a regulatory or compliance officer of the entity managing the chatbot may be alerted. The service provider managing the privacy protection chatbot may also, when authorized and provided controls and/or permissions, perform actions to prevent or minimize risk, loss, and/or other damage due to the exposure, including stopping the chatbot or preventing the chatbot from accessing and/or responding with certain data including the privacy data at risk, taking the bot offline, fixing the exploit, and the like.

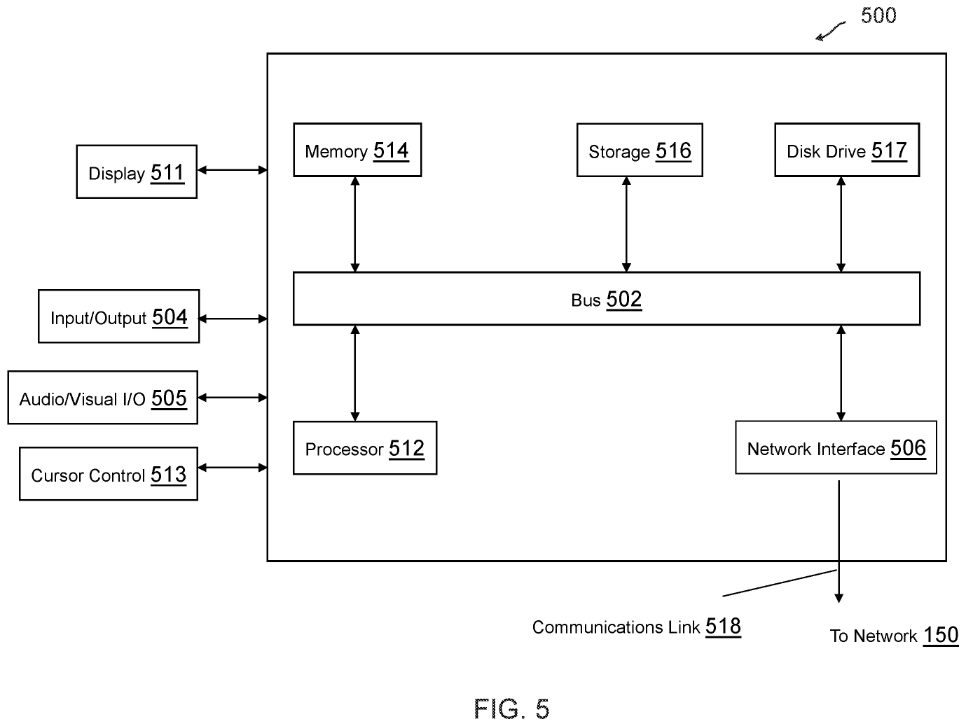

FIG. 5 is a block diagram of a computer system 500 suitable for implementing one or more components in FIGS. 1A and 1B, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
responsive to initiating a privacy protection process for detecting exposures of privacy protected data during uses of a communication service by users, determining an automated chatbot system that provides the communication service to the users;
instantiating a first chatbot for a chat session with a second chatbot of the automated chatbot system;
determining chat session parameters for the chat session with the second chatbot;
connecting the first chatbot with the second chatbot of the automated chatbot system based on the chat session parameters, wherein the second chatbot provides the communication service in conjunction with user data that includes the privacy protected data; determining a first question to be queried by the first chatbot to the second chatbot based on the chat session parameters and a machine learning (ML) model configured for question generation to detect exposure of the privacy protected data;
querying, by the first chatbot, the second chatbot using the first question and the chat session parameters;
receiving a response to the first question from the second chatbot; and
identifying whether any of the privacy protected data is found in the response.

2. The system of claim 1, wherein the detecting the automated chatbot system comprises:
identifying an internal computing platform or a third-party computing platform that utilizes the automated chatbot system; and
determining one of a website chat interface, a chat application instance, or an application programming interface (API) utilized to instantiate the second chatbot,
wherein the chat session parameters are determined based on the one of the website chat interface, the chat application instance, or the API.

3. The system of claim 2, wherein the connecting is performed through the one of the website chat interface, the chat application instance, or the API and causes the internal computing platform or the third-party computing platform to instantiate the chat session with the first chatbot in response to an initial chat request by the first chatbot.

4. The system of claim 1, wherein prior to the querying, the operations further comprise:
determining a second question to be queried by the first chatbot to the second chatbot based on the chat session parameters and the ML model, wherein the first question is a question designed independent of customer-specific information, and wherein the second question is a customer-specific question designed using the customer-specific information; and
querying, by the first chatbot, the second chatbot using the second question with the first question,
wherein the response includes sub-responses to the first question and the second question.

5. The system of claim 1, wherein the querying comprises the first chatbot transmitting a chat message in the chat session to the second chatbot or issuing an API request including the first question during the chat session to the second chatbot.

6. The system of claim 5, wherein the first chatbot interacts with the second chatbot using one or more chatbot application operations without requiring an open interface browser or an open application session to transmit the chat message or issue the API request.

7. The system of claim 1, wherein the first chatbot is one of a plurality of chatbots individually trained on a domain-specific knowledge for each of a plurality of communication services, and wherein the ML model is specific to the domain-specific knowledge of the communication service provided by the second chatbot based on one or more rules, laws, or regulations governing uses of the user data including the privacy protected data by the second chatbot.

8. The system of claim 1, wherein, prior to the connecting, the operations further comprise:
collecting data privacy requirements for at least one of laws, rules, or regulations governing the second chatbot providing the communication service to the users;
training the ML model based on at least one of the laws, the rules, or the regulations; and
creating a plurality of questions including at least the first question using the ML model and one or more business rules associated with the communication service.

9. The system of claim 8, where the training the ML model is further based on domain-specific knowledge of a domain associated with the communication service, wherein the one or more business rules are associated with the domain, and wherein the communication service is provided via one or more communication channels where the data privacy requirements are enforced.

10. The system of claim 9, wherein the laws include general data protection regulation (GDPR) law, and wherein the one or more communication channels include one or more of an email channel, a text message channel, a push notification channel, or an instant message channel.

11. A method comprising:
identifying an online platform providing a communication service that utilizes user data of users that includes privacy protected data, wherein the communication service shares the user data using at least a second chatbot for automated chat communication sessions;
instantiating a first chatbot configured for detection of exposures of the privacy protected data by the communication service;
determining chat session parameters for a chat communication session with the second chatbot that provides the communication service to the users;
establishing, by the first chatbot with the second chatbot, the chat communication session based on the chat session parameters, wherein the communication service by the second chatbot shares user data that includes the privacy protected data during different chat communication sessions based on received questions;
generating, by the first chatbot using a machine learning (ML) model configured for question generation to detect exposure of the privacy protected data, a question based on the chat session parameters, wherein the question queries the second chatbot for a response that includes or utilizes the user data;
transmitting, by the first chatbot, the question to the second chatbot during the chat communication session;
receiving the response to the question from the second chatbot; and
parsing the response for a presence of one or more data portions of the privacy protected data.

12. The method of claim 11, further comprising:
training the ML model using regulatory data associated with at least one location and uses of the privacy protected data in the chat session when providing the communication service in association with the at least one location.

13. The method of claim 12, further comprising:
aggregating the regulatory data from a plurality of online resources associated with regulatory entities for the at least one location.

14. The method of claim 11, wherein the ML model and the first chatbot are domain-specific to a domain associated with at least one of the communication services or a data type of the privacy protected data.

15. The method of claim 14, wherein the question is further generated based on domain-specific knowledge of the domain, and wherein the domain-specific knowledge is associated with uses of the user data by the online platform for the domain.

16. The method of claim 11, wherein the question is generated without use of customer-specific information for a topic of the user data.

17. The method of claim 11, wherein the question is generated using customer-specific information for a real customer account or a faked customer account.

18. A non-transitory machine-readable medium having stored thereon machine-readable instructions executable to cause a machine to perform operations comprising:
instantiating a first chatbot in a chat session with a second chatbot providing a communication service to users, wherein the first chatbot is configured for detection of exposures of privacy protected data by the chatbot;
generating a question by the first chatbot using a machine learning (ML) model configured for question generation to detect the exposures of the privacy protected data using regulatory data associated with at least one of the second chatbot, the communication service, or the privacy protected data, wherein the question is generated based on chat session parameters for the chat session, wherein the question is generated to request the privacy protected data in a response from the second chatbot;
issuing, by the first chatbot, the question to the second chatbot during the chat session;
receiving the response to the question from the second chatbot; and
determining that the response includes the privacy protected data; and
flagging the second chatbot for a review based on the determining that the response includes the privacy protected data.

19. The non-transitory machine-readable medium of claim 18, wherein the regulatory data is domain-specific to a domain of operation of the second chatbot with the communication service.

20. The non-transitory machine-readable medium of claim 18, wherein the flagging the second chatbot includes at least one of preventing the second chatbot from using or accessing the privacy protected data or causing the second chatbot to be unresponsive to further questions associated with the privacy protected data.
